(19) United States
(12) Patent Application Publication
(10) Pub. No.: US 2010/0291305 A1
(43) Pub. Date: Nov. 18, 2010

(54) DECREASED EVAPORATION WITH RETARDER FOR A HIGH WATER TO STUCCO RADIO LIGHTWEIGHT BOARD

(75) Inventors: James R. Wittbold, Des Plaines, IL (US); Bruce Lynn Petersen, Lisle, IL (US); Alfred Li, Naperville, IL (US)

Correspondence Address: GREER, BURNS & CRAIN, LTD., 300 SOUTH WACKER DRIVE, SUITE 2500, CHICAGO, IL, 60603, US

(73) Assignee: United States Gypsum Company, Chicago, IL (US)

(21) Appl. No.: 12/681,681

(22) PCT Filed: Dec. 23, 2008
(86) PCT No.: PCT/US08/88185

§ 371 Date: Jun. 4, 2010

Related U.S. Application Data
(60) Provisional application No. 61/017,446, filed on Dec. 28, 2007.

(51) Int. Cl. C04B 28/14; C04B 24/16; B05D 3/02

(52) U.S. Cl. 427/372.2; 106/772; 106/778; 106/785; 106/15.05; 106/18.26; 524/3

(57) ABSTRACT

A gypsum slurry includes calcium sulfate hemihydrate, a set retarder in amounts of at least 0.15 lb/MSF, a set accelerator, water and aqueous foam. The set accelerator is selected to provide nucleation sites for crystallization of calcium sulfate dihydrate and is present in amounts of at least 5 Ib/MSF. The water to calcium sulfate hemihydrate ratio is at least 0.95. Further, aqueous foam is added in amounts sufficient to create a gypsum board having a dry density of about 29 to about 35 lbs/ft³.

### CROSS REFERENCE TO RELATED APPLICATIONS

This application claims the benefit of co-pending U.S. Provisional Application No. 60,017,446, filed Dec. 28, 2007, entitled “Decreased Evaporation with Retarder for a High Water to Stucco Ratio Lightweight Board.”

### BACKGROUND OF THE INVENTION

The present invention relates to a process for making a slurry for gypsum panels. More particularly, the present invention relates to a slurry for a lightweight gypsum panel having a high water stucco ratio (“WSR”). Even more particularly, the present invention relates to the addition of a retarder to increase the fluidity of the gypsum slurry for a lightweight board having a WSR, while at the same time, reducing the initial time set and the amount of water used.

Gypsum is popular for use in building materials for a number of reasons. The raw materials are inexpensive and readily available. The raw gypsum is dehydrated to form calcium sulfate hemihydrate, also known as stucco. In this form, it is less expensive to ship and store as it is compact and lower in weight. Upon rehydration, the gypsum is shapeable into any desired form. Properties of the formed gypsum products are affected by the amount of water used to rehydrate the stucco. It is generally known that the addition of set accelerators increases strength in gypsum board because more available nucleating sites are concentrated into a smaller volume of the mix. Additional nucleation leads to a matrix on calcium sulfate dihydrate crystals that are more tightly interwoven, leading to a stronger product. Conversely, the addition of set retarders is believed to reduce strength because delay in the adsorption of the water dilutes the nucleation sites longer. The use of gypsum slurries having a high WSR is less desirable. The time to set is longer and the strength and integrity of the board can be compromised. Where excess water is driven off in an oven or kiln, energy costs increase proportionially with the amount of water added to the slurry in excess of that needed for hydration.

Retarders are used to adjust the initial setting reaction of the slurry until after the stucco/water slurry has exited the mixer. This eliminates or reduces plugging or other interference within the mixer and other manufacture processing equipment. As the slurry hardens, stiffening of the reactive powder blend may occur very rapidly within the mixer, including soon after water is added to the mixture. This results in clean-up issues, where a build-up of set gypsum will interfere with the functions of the mixer, causing it to operate improperly.

The addition of a retarder will reduce the initial stiffening time of the gypsum slurry and increase fluidity of the slurry, thereby allowing the fluid gypsum slurry to move through the mixer and other manufacturing equipment without setting and causing manufacturing problems. A gypsum slurry having a high WSR and being treated with a retarder increases fluidity and decreases the set time even more.

### SUMMARY OF THE INVENTION

A gypsum slurry having a high WSR for a lightweight gypsum panel where the slurry has increased fluidity and a reduced initial amount of time to set is provided. This is accomplished through the addition of a set retarder, which also maintains or increases the strength of the resultant gypsum panel. It is also contemplated that a set accelerator can also be added to the gypsum slurry in amounts of at least 5 lb/MSF. This increases the number of nucleation sites, improves hydration and thereby the strength of the final product.

In one embodiment, a lightweight gypsum panel having a finished density of about 29 to about 35 lbs/ft³ is provided. The gypsum panel includes a gypsum core that has an interlocking matrix of calcium sulfate dihydrate crystals and entrained air (foam) to provide the desired density and water. The WSR is at least 0.9 or 0.95. Also included in the gypsum panel are a set retarder and a set accelerator.

In another embodiment, a method of forming a lightweight gypsum panel having a high WSR is provided. The method includes the step of mixing a calcined gypsum with water to form a gypsum slurry. The gypsum slurry includes the characteristic of have a high ratio of water to the calcined gypsum. A set retarder is then added to the gypsum slurry, which is allowed to set. The lightweight gypsum panel is then finished by adding facings to the set gypsum slurry.

### BRIEF DESCRIPTION OF THE DRAWINGS

FIG. 1 is a plot of slump size as a function of retarder dose using the data of Table I;

FIG. 2 is a plot of the normalized strength as a function of retarder dose for the data of Table II.

### DETAILED DESCRIPTION OF THE INVENTION

The present invention relates to the manufacture of gypsum panels that are lightweight. Surprisingly, it has been found that the addition of a set retarder maintains strength or strengthens a lightweight gypsum panel made with a high water to stucco ratio (“WSR”) while at the same time increasing fluidity (as measured by slump) and extending stiffening time of the gypsum slurry. The term “lightweight” is intended to include gypsum boards having a weight of from about 1200 to about 1400 pounds/MSF.

During the formation of a gypsum slurry for use in the gypsum panel, the fluidity of the slurry can be increased by adding a retarder to the gypsum slurry. The addition of a retarder extends the initial set time of the slurry. Gypsum slurries for use in accordance with the present invention preferably also include an increase in the amount of hydration enhancing additives, such as set accelerators. By extending the initial set time of the gypsum slurry, the amount of water to bring the slump or fluidity back to normal is also reduced.

The addition of a retarder and a hydration enhancing additive, or set accelerator, extends the initial stiffening of the slurry which increases the fluidity of the mix, while still allowing the same percentage of the gypsum slurry to set at points during the manufacturing process, such as at the knife to cut the gypsum panels. Bringing the initial fluidity or slump back to normal will allow a reduction in water in the slurry and subsequent reduction in the time required for evaporation of excess water within the gypsum slurry.

It is contemplated that the addition of a retarder to increase fluidity is applicable to both beta and alpha stucco. It is also contemplated that the addition of a retarder is applicable with or without a dispersant and whether a naphthalene sulfonate or polycarboxylate ether is used. It is also contemplated that the addition of a retarder is applicable whether it is used with treated or untreated stucco.

The water to stucco ratio is an important parameter, as would be understood and appreciated by those of ordinary skill in the art. The water to stucco ratio expresses the amount of water per amount of stucco, and is important since excess water must eventually be driven off by heating, which is expensive due to the high cost of the fuels used in the heating process. It has been shown that the use of a retarder within a gypsum slurry is especially effective to increase fluidity allowing reduction of the water/stucco ratio and/or increasing hydration enhancing additives to a high water/stucco ratio slurry. A high water to stucco ratio may be defined as those ratios closest to one, i.e., where there are about equal parts of water and stucco.

The lower water usage will increase the effect of the gypsum crystal growth during setting because available nucleating sites are concentrated into a smaller volume of the mix. Interaction of growing gypsum crystals occurs earlier and is more effective and is therefore believed to provide improved strength in the final products. Gypsum panels in accordance with the present invention have a high water to stucco ratio and maintain strength in a lightweight product through the addition of a set retarder.

Set retarders are typically added to increase the initial set time of the gypsum slurry. It is known to add particular retarders to attain a desired initial set time. Any set retarder known to be useful with calcium sulfate dihydrate is suitable in amounts to produce working times consistent with a desired target range, as would be appreciated by those skilled in the art. Initial retarder used varies from manufacturing plant to manufacturing plant. Some plants choose to not initially use retarder at all while others may use as much as 0.1% retarder based on the stucco usage. When used in combination with other aspects of this invention, the set retarder also affects the strength of gypsum board. In some embodiments, the retarder is used in increasing amounts from about 50% to about 300%, based on the initial amount of retarder being used. Yet other embodiments will utilize from about 0.15 to about 0.9 lb/msf. The exact amount of retarder required varies with, among other things, the type of stucco added, the amount and type of set accelerator that is used.

A preferred set retarder for use in lightweight gypsum panels of the present invention is VERSENEX 80, a chelating agent obtained commercially from Van Walters & Rogers of Kirkland, Wash. (sodium diethylenetriaminepentaacetate). It has also been found the addition of sodium citrate, citric acid, tartaric acid, sodium tartrate or the like will provide adequate set retardation in concentrations that are known to those skilled in the art. Where longer set times are desired, proteinaceous materials such as casein may be used in concentrations that are known to skilled practitioners.

Other acceptable set retarders, for use in accordance with the present invention, also include polymers, phosphates, sodium salts, proteins and the like. In addition, other retarders include at least one of a sodium salt of polyacrylic acid, an acrylic acid sulfonic acid copolymer, an ammonium salt of an acrylic acid sulfonic acid copolymer, a sodium salt of an acrylic acid sulfonic acid copolymer, or a blend of an acrylic acid polymer with a sulfonic acid copolymer and salts thereof.

The slurry and panel also include a set accelerator of the type that provides nucleation sites for crystal development. “CSA” is a set accelerator comprising 95% calcium sulfate dihydrate co-ground with 5% sugar and heated to 250° F. (121° C.) to caramelize the sugar. CSA is available from USG Corporation, Southard, Okla. plant, and is made according to U.S. Pat. No. 3,573,947, herein incorporated by reference. Potassium sulfate is another preferred accelerator. HRA is calcium sulfate dihydrate freshly ground with sugar at a ratio of about 5 to 25 pounds of sugar per 100 pounds of calcium sulfate dihydrate. It is further described in U.S. Pat. No. 2,078,199, herein incorporated by reference. Other examples of useful set accelerators include sodium carbonate, calcium chloride, calcium nitrate, calcium nitrite, calcium formate, calcium acetate, sulfates, acids and calcium sulfate dihydrate. It is contemplated that these accelerants are useful individually or in any combination thereof. These accelerators all accelerate crystal growth by providing seed crystals to encourage nucleation. Accelerators of this type are used in amounts of about 5 to about 25 pounds based on 1000 square feet of dry, finished board (“MSF”).

Other types of accelerants are useful in addition to accelerators that provide nucleation sites. One example of another type of accelerant is alum, which speeds crystal growth by enhancing the solubility of one or more of the slurry components. Solubility-enhancing accelerators are optionally used in addition to but not as replacements for accelerators that provide nucleation sites.

Other additives may be added to the gypsum slurry as would be appreciated by those skilled in the art. Other conventional additives can be employed in the practice of the invention in customary amounts to impart desirable properties and to facilitate manufacturing, such as, for example, aqueous foam, set accelerators, set retarders, recalcination inhibitors, binders, adhesives, dispersing aids, leveling or nonleveling agents, thickeners, bactericides, fungicides, pH adjusters, colorants, reinforcing materials, fire retardants, water repellants, fillers and mixtures thereof.

Slump is a measurement of a gypsum slurry's fluidity or workability. Slump is a measurable quantity that assists in determining whether there is too much water is in the gypsum slurry. A slurry sample is poured into a damp 2″×4″ cylinder placed on a plastic sheet, slightly overfilling the cylinder. Excess material is screeded from the top, and then the cylinder is lifted up smoothly, allowing the slurry to flow out the bottom, making the patty. The patty is measured (±⅛″) in two directions 90° apart, and the average reported as the patty diameter.

In one embodiment in accordance with the present invention, a method for forming a lightweight gypsum panel is provided. The lightweight gypsum panel is formed from a gypsum slurry having a high water to stucco ratio. The lightweight gypsum panel with lower WSR maintains or increases strength over existing gypsum panels having high water to stucco ratios.

To form a lightweight gypsum panel, a calcined gypsum is first mixed with water to form a gypsum slurry. In accordance with an embodiment of the present invention, gypsum slurries preferably have a WSR of at least 0.95. In some instances, it is preferred to have about a one to one ratio of water to stucco. In other instances, it is preferable to have a 95 to 100 ratio of water to stucco. The set retarder maintains or increases the overall strength of the gypsum panel. The gypsum slurry is shaped into a panel, preferably by sandwiching it between two sheets of facing material. Finishing processes for gypsum panels include any of those as would be appreciated by those of ordinary skill in the art.

It is also contemplated that a set accelerant can be added to the gypsum slurry prior to setting and after or concurrently with addition of the set retardant to the slurry. Preferably, the retarder is added to the gauging water or through spray nozzles in the mixer for good distribution of the retarder in the slurry. In other embodiments, it is contemplated that the set accelerant can be added prior to the set retardant. Set accelerants for use in the present invention include those as described therein. A preferred set retardant can be a chelating agent. It is further contemplated that an additive can be added after the set retarder is added to the gypsum slurry. In certain embodiments, it is contemplated that at least one additive can be added to the gypsum slurry before the set retarder. It is also contemplated that an additive can be added prior to a set accelerant. The addition of set retarders, set accelerants and other additives can occur in an order, as would be appreciated by those skilled in the art.

### Example 1

Lab tests were conducted to measure the effect of varying the amount of a retarder in a gypsum slurry having a high water to stucco ratio. A constant WSR of 0.95 was used in the following tests using 380 grams of stucco and 400 grams of water for each run. Six grams of DAXAD dispersant was used in each of the runs, and a constant 1.2 grams of MCM was also used. The set retarder was VERSENEX 80, a chelating agent obtained commercially from Van Walters & Rogers of Kirkland, Wash. As can be seen, the amount of the retarder was varied, while all other characteristics remained the same.

TABLE 1

| | Set Retarder, | CSA, | | Stiffing Time, |
|---|---|---|---|---|
| Run | grams (lb/MSF) | grams | Slump, cm | min:sec |
| 1 | 0 | 0.40 | 19.1 | 2:10 |
| 2 | 0.064 (0.14) | 0.43 | 19.4 | 2:15 |
| 3 | 0.13 (0.29) | 0.48 | 19.5 | 2:15 |
| 4 | 0.19 (0.43) | 0.70 | 21.6 | 2:20 |
| 5 | 0.26 (0.59) | 1.00 | 23.0 | 2:20 |

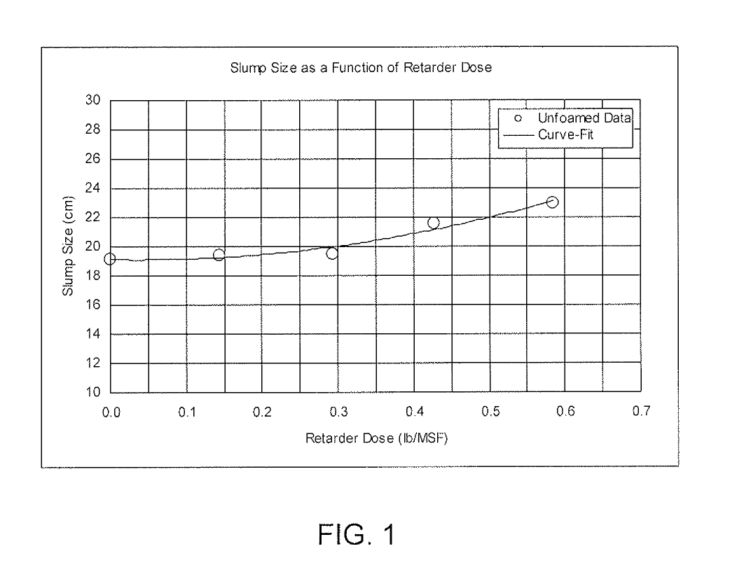

As shown in Table 1, at a low dose of set retarder (<0.3 lb/MSF), no fluidity improvement can be found. At a retarder dose above 0.43 lb/MSF, however, slurry fluidity improves significantly while maintaining similar stiffening time. An increase of fluidity will allow more water reduction and/or dispersant reduction. In reviewing the slump data in view of the retarder dose, as shown in FIG. 1, it can be seen that the fluidity of the slurry remains relatively constant below 0.3 lb/MSF of retarder.

### Example 2

### Versonex 80-CSA Cube Strength Procedure

Several samples were prepared using the formulation:

1000 gm Southard CKS stucco

1400 ml Tap water @ 70° F.

Versonex-80 as shown in Table II

5 grams of East Chicago HRA

Dry ingredients (stucco and HRA) were added to a large plastic bag and mixed thoroughly for 30 seconds. 1300 ml water was added to large Warring blender. Versonex-80 was mixed with 4 parts water to help with accuracy of solution due to small amount added into mixture (10 gm Versonex and 40 gm water as initial dilution). Additional water was added to cup to make up 100 ml of water along with Versonex-80. Total water equaled 1400 ml. The contents of the cup were added to the blender. Timer was started and dry mixture was added at 10 seconds for a 7 second soak. At 17 seconds, the large 4 L warring blender was turned on at high speed for 7 seconds mixing time. At 24 seconds, the blender was turned off and lid was removed. The slurry was poured into the six cube molds. At 55 seconds, the extra mixture from the top of the slump cup was scraped off. At one minute the extra slurry was also removed and/or scraped-off of the top of the cube molds and the cubes were allowed to set in the cube mold for ten additional minutes. Cubes were placed into a BLUE M oven set @116° F. and left to dry for at least 48 hours prior to the testing cube compression upon the ATS machine. This procedure was repeated twice for each condition so a total of twelve cubes were generated and averaged.

TABLE 2
Strength Test Data

| | Amount of Retarder, | Compressive | Normalized |
|---|---|---|---|
| Run | grams | Strength, psi | Strength, % |
| 6 | 0.05 | 936 | 185 |
| 7 | 0.10 | 901 | 184 |
| 8 | 0.15 | 908 | 180 |
| 9 | 0.20 | 911 | 183 |
| 10 | 0.25 | 909 | 184 |
| 11 | 0.30 | 928 | 184 |
| 12 | 0.40 | 960 | 194 |
| 13 | 0.60 | 899 | 197 |

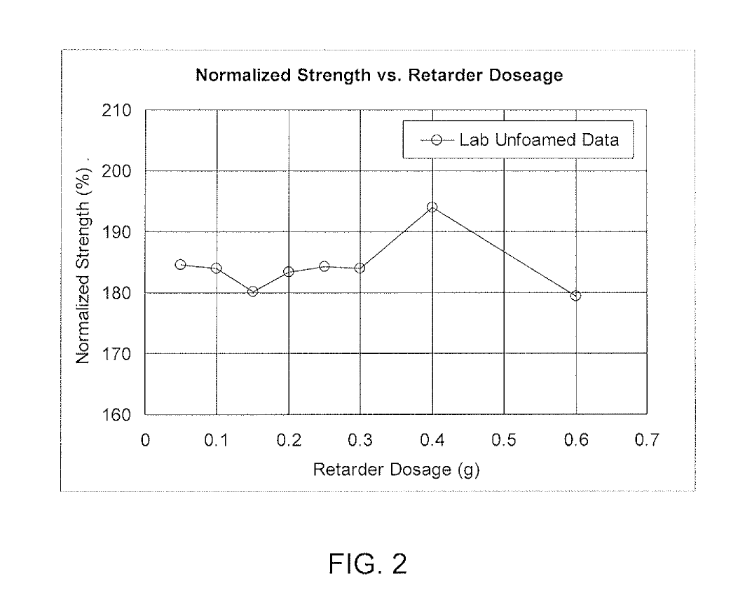

A graph of the normalized strength as a function of the amount of retarder is shown in FIG. 2. “Normalized strength” is a calculated value comparing the strength of the sample to a theoretical sample that has been adjusted to compensate for changes in density. At low amounts of retarder, the normalized strength falls, then rises at higher retarder concentrations. Overall, at a WSR of 1.4, higher doses of retarder maintains or improves product strength.

While a particular embodiment of the present gypsum slurries including a retarder have been described herein, it will be appreciated by those of ordinary skill in the art that changes and modifications may be made thereto without departing from the invention in its broader aspects and as set forth in the following claims.

What is claimed is:

1. A gypsum slurry comprising:
calcium sulfate hemihydrate;
a set retarder in amounts of at least 0.15 lb/MSF;
a set accelerator in amounts of at least about 5 lb/MSF, wherein said set accelerator is selected to provide nucleation sites;
water, wherein the water to calcium sulfate hemihydrate ratio is at least 0.90; and
aqueous foam in amounts sufficient to create a dry gypsum board having a density of about 29 to about 35 lbs/ft³.

2. The gypsum slurry of claim 1 wherein said water to calcium sulfate hemihydrate ratio is at least about one to one.

3. The gypsum slurry of claim 1 wherein said water to calcium sulfate hemihydrate ratio is more than about one to one.

4. The gypsum slurry of claim 1 wherein said set accelerant is selected from at least one of sodium carbonate, calcium chloride, calcium nitrate, calcium nitrite, calcium formate and calcium acetate.

5. The gypsum panel of claim 1 further including an additive.

6. The gypsum slurry of claim 5 wherein said additive includes recalcination inhibitors, binders, adhesives, dispersing aids, leveling or nonleveling agents, thickeners, bactericides, fungicides, pH adjusters, colorants, reinforcing materials, fire retardants, water repellants, fillers and mixtures thereof.

7. The gypsum slurry of claim 1 wherein said retardant is a chelating agent.

8. The gypsum panel of claim 1 wherein said retardant is selected from at least one of sodium citrate, citric acid, tartaric acid, sodium tartrate, a sodium salt of polyacrylic acid, an acrylic acid sulfonic acid copolymer, an ammonium salt of an acrylic acid sulfonic acid copolymer, a sodium salt of an acrylic acid sulfonic acid copolymer, or a blend of an acrylic acid polymer with a sulfonic acid copolymer and salts thereof.

9. A method of forming a lightweight gypsum panel, comprising the steps of:
selecting a set accelerator to provide nucleation sites for formation of calcium sulfate dihydrate crystals;
providing an amount of calcium sulfate hemihydrate;
combining the calcium sulfate hemihydrate, the set accelerator and a set retarder with gauging water to form a gypsum slurry, wherein the ratio of water to calcium sulfate hemihydrate is at least 0.95, the set accelerator is present in an amount of at least about 5 lbs/MSF and the set retarder is present in an amount of at least 0.15 lb/MSF.
reducing the density of the gypsum slurry by adding an aqueous foam;
forming the slurry into a panel; and
allowing the gypsum panel to set.

10. The method of claim 9 wherein said combining step includes adding the set retarder to the gauging water.

11. The method of claim 9 wherein the accelerant is selected from at least one of sodium carbonate, calcium chloride, calcium nitrate, calcium nitrite, calcium formate and calcium acetate.

12. The method of claim 9 wherein the retardant is a chelating agent.

13. The method of claim 9 wherein the retardant is added to the gauging water prior to calcium sulfate hemihydrate addition.

14. The method of claim 9 wherein said combining step further comprises adding an additive.

15. The method of claim 14 wherein the additive includes recalcination inhibitors, binders, adhesives, dispersing aids, leveling or nonleveling agents, thickeners, bactericides, fungicides, pH adjusters, colorants, reinforcing materials, fire retardants, water repellants, fillers and mixtures thereof.

16. The method of claim 9 wherein said forming step comprises pouring the slurry onto a facing material.

17. The method of claim 9 wherein the ratio of water to calcium sulfate hemihydrate is at least one to one.
